(19) United States
(12) Patent Application Publication
(10) Pub. No.: US 2010/0333158 A1
(43) Pub. Date: Dec. 30, 2010

(54) Analysis of Packet-Based Video Content

(75) Inventors: Tony McCormack, Galway (IE); Alan Diskin, Galway (IE); Neil O'Connor, Galway (IE)

Correspondence Address: BARNES & THORNBURG LLP, One NOrth Wacker Drive, CHICAGO, IL, 60690-2786, US

(73) Assignee: Nortel Networks Limited, St. Laurent (CA)

(21) Appl. No.: 12/494,594

(22) Filed: Jun. 30, 2009

(51) Int. Cl. H04N 7/173; H04N 7/26

(52) U.S. Cl. 725/109; 725/132; 375/240.25; 704/251; 375/E07.027

(57) ABSTRACT

A system for receiving and decoding packet-based video signals, and method of operation and computer program product for such system are disclosed. The system receives a packet-based data stream encoding a video or television signal. The content is analysed in accordance with user-editable rules to find matches between conditions specified in the rules and corresponding actions to be taken. On detection of a match with the received content, a corresponding action is implemented by issuing a command to control a component which is under the control of said receiving and decoding system.

### TECHNICAL FIELD

This invention relates to the analysis of packet-based video content.

### BACKGROUND ART

Packet-based video is referred to herein interchangeably as IPTV (an abbreviation for Internet Protocol Television), and encompasses simple video delivery services such as YouTube and Google Video, in which a video/audio stream is delivered on demand to a user's computer, as well as more sophisticated services providing richer content, usually on a subscriber basis, such as AT&T's UVerse service and British Telecom's BT Vision service. (“YouTube”, “Google Video”, “UVerse” and “BT Vision” are trademarks owned by YouTube Inc., Google Inc., AT&T and British Telecom, respectively.)

One of the key attractions of IPTV is that it allows for integration with other services, such as telephony, video conferencing, email and instant messaging (IM). Thus, for instance, a user's telephone system may be integrated with an IPTV set top box (STB) so that when an incoming call is received, the caller ID is displayed on-screen to a user watching television.

The richer nature of IPTV data streams also allows program makers to tag the stream with metadata describing the content or relating to the content. In this way, a television program can be tagged as being a wildlife documentary, or the program maker may embed active content with which the viewer can interact on-screen (e.g. “Click here to email the newsdesk” or “For more information on patents, click here”, with these respective links launching an email client and a browser, respectively, integrated with the set top box or user's personal computer).

A problem with such tagging is that it can be intrusive to the viewer, or it may not correctly tag the content according to the viewer's viewpoint. For example, the viewer may not be interested in “Football games” generally, or “Hockey games” generally, but may have a particular interest in a program involving his or her local community and may be interested in a game involving the local football or hockey team. If the program content is not correctly and richly tagged to identify the local sports teams, then the viewer may not be made aware that a program of interest is available. Such granular and rich tagging necessitates additional overheads and costs which are ultimately borne by the user in subscription fees.

### DISCLOSURE OF THE INVENTION

There is provided a method of operating a system for receiving and decoding packet-based video signals, comprising the steps of:

(a) receiving a packet-based data stream encoding a video signal;

(b) maintaining a set of rules, each rule specifying a content-matching condition and a corresponding action to be taken;

(c) providing an interface for a user of the receiving and decoding system to edit said set of rules;

(d) analysing the content of the packet-based data stream to determine whether the content thereof matches a condition specified in one of said rules;

(e) upon determination of a matching condition in said analysing step, implementing a corresponding action specified in said one of said rules, said action being effective to control a component which is under the control of said receiving and decoding system.

Instead of tagging content with metadata at the time of program creation or at the time of multicast or upload to an IP network, this method provides the user of the receiving system (e.g. the viewer or owner of the receiving system) with the ability to specify the particular content of interest and the action to be taken when such content is received and detected.

This frees the user from being constrained by the metadata supplied by the program maker, service provider or network operator, and allows the user to enrich the viewing experience in accordance with criteria which may be very different to those employed by content providers.

As used herein, the terminology of “a packet-based data stream encoding a video signal” encompasses streams encoding signals with both video components and audio components. Analysis of such a stream may involve the analysis of just an audio component, just a video component, or both.

Preferably, the step of analysing the content of the packet-based data stream comprises decoding the packet-based data stream and analysing the decoded signal.

It may be possible for a user to specify rules which are effective to identify a relevant condition in the encoded data stream, but in the majority of cases it is envisaged that the rules will specify conditions relating to the decoded content.

Further, preferably, the step of analysing the decoded signal comprises analysing an audio component of the decoded signal to detect audio content matching said condition in one of said rules.

The audio content matching a condition may be music, sound effects, or spoken content. A particularly preferred embodiment involves identifying spoken content matching user-determined rules.

Preferably, therefore, the step of analysing an audio component comprises applying speech analytics techniques to match detect a match with one or more spoken words or word patterns specified by said user in said interface for editing said set of rules.

This provides the user with a powerful technique for a richer viewing experience. By specifying spoken content matching one or more keywords or word patterns (for example, a URI, email address, name of sports team, or topic of interest), the user can specify in advance that certain actions should be taken, such as to switch to another channel, to display an alert on screen, to launch a communications program, or to influence the actions of a computer system, to give a few non-limiting examples.

This is not the same as receiving a tagged audio stream (with closed captions or with metadata representing the full audio content. Because the speech analytics are applied at the user equipment, there is no reliance on the content provider to have analysed and tagged the spoken content, and the processing requirements can be greatly reduced if all that is required is the determination of a match with a limited set of rules, perhaps a dozen or a couple of hundred keywords.

Alternatively or additionally, the step of analysing the decoded signal comprises analysing a video component of the decoded signal to detect video content matching said condition in one of said rules.

While audio matching is currently a preferred way of providing untrained users with a means to identify content of interest, more sophisticated users may wish to identify graphical elements in a picture which they can themselves specify. It is envisaged that with advances in processing power, in graphical interfaces, and with increasing computer literacy among the general populace, such techniques will be increasingly accessible to all users.

Preferably, therefore, the step of analysing a video component comprises applying pattern-matching techniques to identify a match with a visual element specified by said user in said interface for editing said set of rules.

Further, preferably, said visual element comprises a string of text.

In this way, a user might specify the name of his or her employer as a text string of interest, and if that name was identified by text matching techniques, a user-specified action could be initiated (such as to record the channel or to store a flag in a “view later” list), in order that the user could watch the programme mentioning or showing the employer. It will be appreciated that the text matching need not be confined to the identification of a caption or of printed text shown on-screen. An employer's name could equally be identified from a logo or sign in which the name is present. (To continue this example, if the company logo does not include the name in easily recognisable form, the user might upload a graphic file of the company logo so that this could be matched instead.)

Preferably, said step of implementing a corresponding action comprises implementing an action effective to control a component of said receiving and decoding system.

Some of the controllable elements may include the decoder, the picture processor, the data stream control, the channel selection system, a video or audio recording system, a “watch later” list, a program queue, a scene selection system for choosing between multiple scenes or viewing angles, an alerting system, an equipment display, an integral communications client (e.g. email, voice or video telephony, instant messaging, unified communications), and an embedded browser.

Alternatively, said step of implementing a corresponding action comprises implementing an action effective to control a component of a system which is associated with and controllable by said receiving and decoding system.

The associated and controllable system may be a remote control unit, the television set or display screen, a personal computer communicating with the receiving and decoding system over a wired or wireless network, a web server, a video recording system, or any other system which has been configured to grant permission to be controlled by the receiving and decoding system. It will be appreciated that this provides a wide ranging and powerful method allowing a user to specify the address of virtually any networked, controllable device for which the user has control permission, and permits any allowable control signal to be sent to that device, granting a very powerful tool for the user to use received television or video content to automatically control such devices.

The receiving and decoding system can be a dedicated system, such as a proprietary or generic set-top box, or it can be a general purpose or dedicated computer system operating suitable software to implement receiving and decoding functionality. The system may reside on a single device or it may be distributed on a number of networked devices operating in conjunction with one another.

The received packet-based data stream encoding a video signal, which is subject to analysis, need not be a stream which has been selected for viewing by the user. The user may be watching a different stream or may not be watching the video or television service at all. For example, typical commercial subscriptions for IPTV allow a user to receive several streams or channels, and the user may be watching one stream on one television, with a family member watching another stream on a networked computer display screen, a third stream being recorded on a personal video recorder (PVR) or hard drive of the set-top box, and fourth, fifth and sixth streams being received but being neither watched nor recorded. Any or all of these stream might be subject to the analysis of content to determine matches with rules editable by the user.

The data stream may be encoded in any suitable format, and the stream may be unicast or multicast. It may represent television channels, video on demand (VOD), closed circuit television, recorded video, or any other video signals. The stream may be hosted by a website such as YouTube, it may be streamed from a non-public network address, it may be streamed using the Internet by a service provider to a subscriber, or it may arrive via another network such as a private fiber or cable network.

There is also provided a corresponding computer program product comprising a program carrier encoding instructions which, when executed by a system for receiving and decoding packet-based video signals, are effective to cause the system to:

(a) maintain a set of rules, each rule specifying a content-matching condition and a corresponding action to be taken;

(b) provide an interface for a user of the receiving and decoding system to edit said set of rules;

(c) analyse the content of a received packet-based data stream encoding a video signal to determine whether the content thereof matches a condition specified in one of said rules;

(d) upon determination of a matching condition in said analysing step, implement a corresponding action specified in said one of said rules, said action being effective to control a component which is under the control of said receiving and decoding system.

The program carrier may be, for example, a magnetic or optical data carrier, a flash memory, an internal memory chip in a computer, or of any other suitable format to store program instructions.

The program may be executed on any stand-alone computing system or any networked combination of systems providing the functionality to receive and decode video signals.

There is also provided a system for receiving and decoding packet-based video signals, comprising:

(a) a network connection for receiving a packet-based data stream encoding a video signal;

(b) a memory storing a set of rules, each rule specifying a content-matching condition and a corresponding action to be taken;

(c) an interface operable by a user of the receiving and decoding system to edit said set of rules;

(d) a content analysis system for analysing the content of the packet-based data stream to determine whether the content thereof matches a condition specified in one of said rules;

(e) a processor programmed to, upon determination of a matching condition in said analysing step, implement a corresponding action specified in said one of said rules, said action being effective to control a component which is under the control of said receiving and decoding system.

### BRIEF DESCRIPTION OF THE DRAWINGS

The invention will now be further illustrated by the following description of embodiments thereof, given by way of example only, with reference to the accompanying drawings, in which:

FIG. 1 is a block diagram of an IPTV network including an exemplary system for receiving and decoding packet-based video signals; and

FIG. 2 is a block diagram illustrating a method of operating a system for receiving and decoding packet-based video signals

### DETAILED DESCRIPTION OF PREFERRED EMBODIMENTS

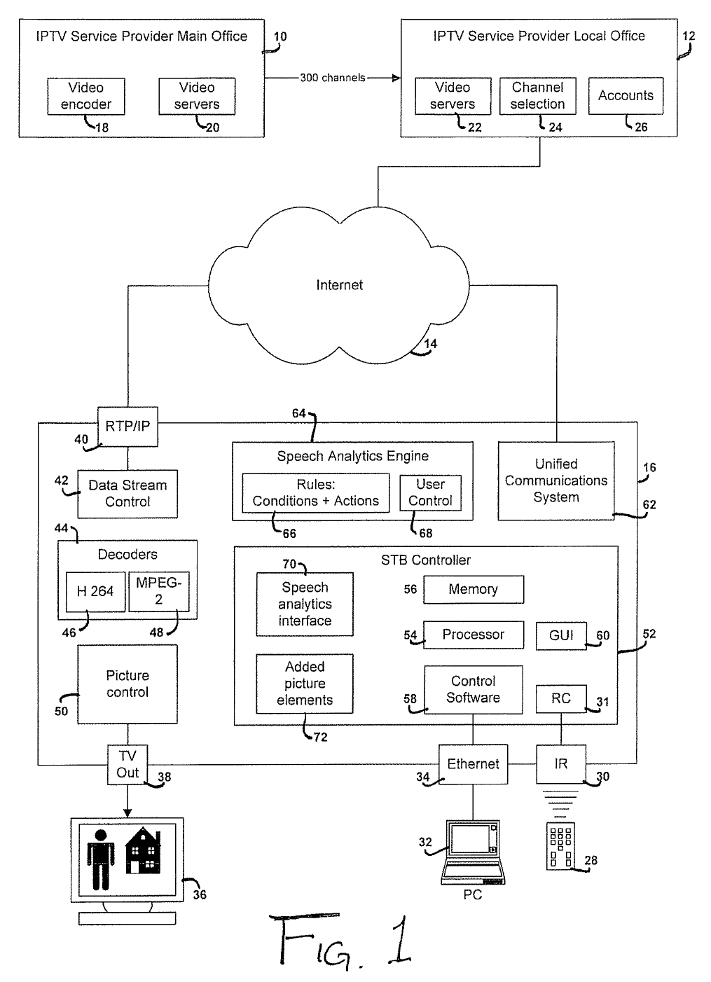

FIG. 1 shows an IPTV network comprising an IPTV service provider's main office 10 and one of its local offices 12, a network 14 for transporting television signals to subscribers of the service (in this case the network is the Internet), and a subscriber's system for receiving and decoding video signals 16.

Television and video-on-demand content is encoded using a suitable standard, such as the H.264 standard of the International Telecommunications Union, using one or more encoders 18 at the main office 10. Content can be immediately sent to the local offices or it may be stored for later delivery by servers 20. Because of bandwidth constraints between subscribers and the Internet, the IPTV service provider transmits large numbers of channels and video streams using dedicated links to each of a number of local offices such as local office 12, and video servers 22 at local office 12 provide signals to each of a subset of subscribers using channel selection and switching routers 24, subject to account verification systems 26. The local office 12 will typically add local advertisements to a program feed at appropriate break points.

The data streams can be augmented by other elements in addition to straightforward audio and video. One of the benefits of IPTV is that the signal can carry email addresses, web links and other uniform resource indicators (URIs), with which the user may interact on-screen, as well as being supplemented with metadata describing the content of the program.

Thus, each subscriber may be sent a feed of (say) between 2 and 10 channels, at least one being actively selected by the subscriber, and the others either being selected by the subscriber or by the IPTV service provider. A user may select several channels to watch on different sets or on the same set using picture-in-picture and other mixing technology, with other channels being selected for recording or monitoring and analysis as described herein. The service provider may automatically fill in the bandwidth with the next channel up and down from the actively watched channel (to promote instantaneous switching when the user is “channel hopping”), or with a user's most watched channel(s) or in any other way, or may conserve bandwidth by limiting the feeds to only the channel(s) requested.

In this way each subscriber can obtain one or more data streams representing channels or video recordings. In the exemplary system, a user or subscriber is provided with receiving and decoding system 16 in the form of a set-top box (STB), this being basically a dedicated computer or processor which is packaged into a small form factor with a dedicated interface providing user control via a remote control unit 28 communicating with an infrared port 30 and RC receiver 31, a PC 32 connected to an Ethernet port 34 (or using wireless connections) or from signals passed back from a television set 36 connected to a TV Out port 38. It will be appreciated that the same functionality can be implemented in software on any suitable computer or set of networked computers. For brevity, the illustrated system 16 will be referred to interchangeably hereinafter as a set-top box or STB.

The PC and remote control are optional, and a user could interact with the STB using any other interface such as voice commands, buttons on the unit, remote commands sent to an IP address of the STB via the Internet, commands from the IPTV service provider (e.g. based on a telephoned request for access to a pay-per-view channel) or by bluetooth signals from a cellphone, to give just a few examples.

Data streams encoding video signals are received using a real time protocol/Internet protocol (RTP/IP) socket 40 and the receipt and selection of data streams is made via a data stream controller 42. In addition to the data streams themselves, other data such as electronic program guide (EPG) information is received.

The data streams are passed to a set of decoders 44. In the illustrated embodiment, the STB is provided with a H.264 decoder 46 and an MPEG-2 decoder 48, but of course more protocols and encoding standards may be catered for. Typically, one or more of the streams are selected by the user for current viewing and these streams are decoded and sent to a picture control processor 50 which formats a signal for playback on the television set 36.

Control of the data stream controller 42, decoders 44 and picture control processor 50 is carried out by a set top box controller 52. This controller 52 will, for example, send a user's channel selection choices, requests for EPG information, video-on-demand subscription requests, and so on to the data stream controller 42. It will send instructions to the decoders 44 as to where each decoded data stream is to be sent (some to the television, some to a video recorder, some to be discarded, etc., taking account of user-selected options such as choosing an alternate scene in a movie or an alternate camera in a sporting event), and it will send instructions to the picture control processor 50 (which may be implemented as a process running on the STB controller's own processor 54) as to how to format the picture to reflect options such as the user's choice of picture-in-picture channels, wide-screen viewing choices, and so on.

As the STB controller is effectively a stripped-down computer with a dedicated operating system, it has, in addition to a processor 54, a memory 56, control software 58, and a graphical user interface or GUI 60. As described previously, the user may interact with the STB controller, to control the actions of processor 54, in many ways, but the two most common control mechanisms are (i) on-screen interactions with the GUI 60 (which is rendered by the picture control processor 50 and with which the user may interact using the remote control 28), and using the same or a different graphical interface accessible via the PC 32. The PC 32 may operate its own STB control software which interacts with the STB control software 58.

The STB is also provided with a unified communications system or UCS 62, which provides communications facilities such as such as email, SMS, instant messaging (chat), presence information, IP telephony, video conferencing, call control and speech control in an integrated package. The UCS 62 is connected to the Internet, and using this facility of the STB, the user may engage in communications with third parties. UCS software is well-known and includes Nortel Network's “Software Communications System”, Microsoft Corporation's “Office Communications Server”, IBM's “Lotus Sametime” and Unison Technologies' “Unison” software (all product names in quotation marks being trade marks of the respective owners). Not all of these products offer all of the same functionality, but in each case, there is a suite of communications clients which interact together and offer a user a choice of communications methods. The UCS need not necessarily be located in the STB, but can instead be provided on PC 30 or remotely on another computer system controllable by the STB. In addition to IP Telephony and UCS, communication systems such as standard enterprise and residential phone services can also be integrated with the IPTV service and controlled using the techniques described here.

The STB is also provided with an speech analytics engine 64 which is operable to receive a signal and perform analytics operations on that signal. For example a speech analytics engine is operable to take an audio signal, and to perform speech recognition and pattern matching on that signal. The speech analytics engine 64 is programmed with rules 66 specifying conditions to be matched against the audio and actions to be taken in response to a detected match. A user control interface 68 is provided to enable user editing of the rules, whereby a user may specify a new condition (such as a combination of keywords, or a match against a profanity list, for example) and an appropriate action (such as change channel and lock channel against reselection, for a parental filter based on profanity, or such as a command to begin recording an unwatched channel when a company's name is detected). The STB may come programmed with a starting set of rules, or the user may download a rule set, or the rules may be entirely user-created. The user must, however, be able to edit at least some of the rules in the rule set.

The STB controller 52 includes an speech analytics interface 70 which allows a user employing GUI 60 (or any other input method) to access the speech analytics engine's user interface 68. The speech analytics interface 70 also receives from the speech analytics engine 64 an indication of any actions to be taken in accordance with the rules. This is preferably in the form of a command which is then appropriately processed and formatted to control another component of the receiving and decoding system, or of some other system which is accessible by and controllable by the receiving and decoding system.

The STB controller 52 also operates a process for added picture elements 72. This process allows the STB controller to create and format additional elements which are added to the video or audio mix presented to the television set 36 by the picture control processor 50. Such additional elements include graphical, auditory and text alerts, and active picture elements with which a user may interact, such as email addresses and hyperlinks.

The use of speech analytics is only one type of analysis engine or process which may be employed or incorporated in a system of this type. One could also employ a music analysis tool to identify musical pieces or other sounds, or such analysis could be done by an external site such as www.shazam.com, or using software such as Tunatic (www.wildbits.com/tunatic).

The analysis can also or alternatively include visual matching software to identify graphics, text strings, faces, movements, or colour combinations, and rules can be set up, if such analysis is provided, to specify conditions to be met by the video signal component.

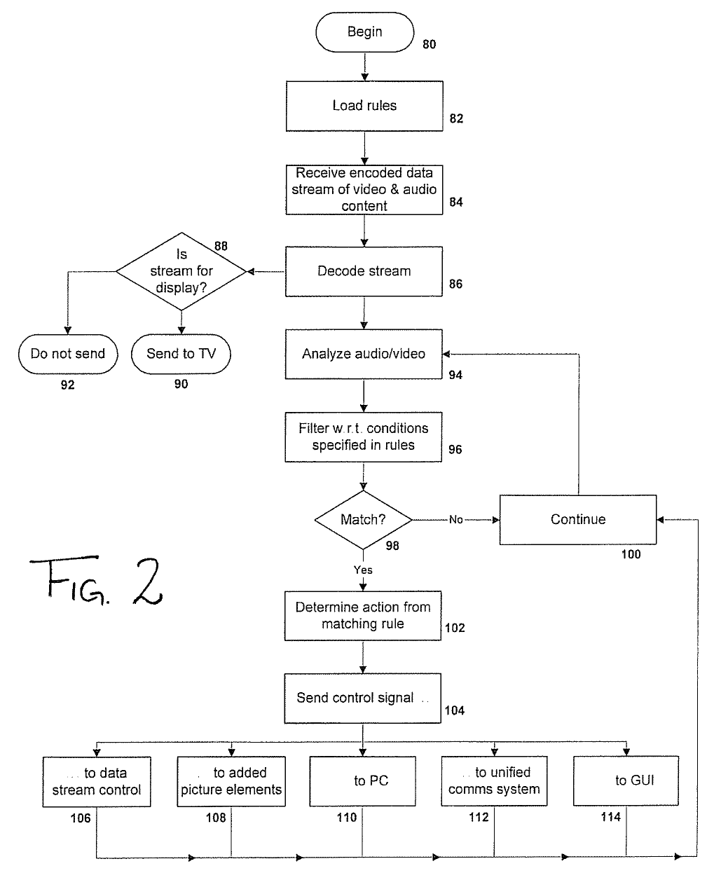

Referring to FIG. 2 in addition to FIG. 1, a method of operation of the STB will now be described.

The process begins in step 80. In step 82, the speech analytics engine 64 loads the rules 66 in preparation for speech the appropriate analysis. The data stream is received, step 84 (in reality a number of streams may be received simultaneously, representing different channels, or several channels may be received in a single data stream), and the stream is decoded, step 86. In step 88, each channel or stream is evaluated to determine if it has been selected for display. If so, it is sent to the picture controller and then to the television or display monitor, step 90. If not, it is not displayed, step 92 (though it may nevertheless be monitored and analysed or sent to a different location such as a recorder).

Each data stream is sent to the audio and/or video analysis engines or services available to or present on the system, step 94, where it is subjected to analysis according to the rules, step 96. The analysis determines if a match is found, decision 98, and if not, the process continues, step 100 with further analysis, step 94.

If a match is found with a condition in a rule, then the associated action is determined from the rule, step 102. The analytics engine sends a command or code to the analytics interface of the STB controller, which in turn formats an appropriate command and sends it to the appropriate component of the system or of another connected system, step 104.

The command may be sent to the data stream controller, step 106, for example to communicate a change in the required data stream to the local office. The command may be sent to the added picture elements process, step 108, to formulate additional passive or active elements to add to the picture mix (meaning adding to the audio, video or data signal components which are sent to the television set). The command may be sent to the PC, step 110, to control an application on that computer. The command may be sent to the unified communications system, step 112, to influence or control the behavior of that system, such as by launching an email or IM or voice or video telephony session. The command may be sent to the GUI, step 114, to control the operation of the GUI such as by presenting a GUI menu to the user on-screen or on a display of the remote control or a display of the PC. It will be appreciated that these components are given as examples only, and that the appropriate command or action specified in the rule may issue to any component which is addressable by and controllable by the STB, whether in the local environment of the user's location or remotely over the Internet or some other network.

The invention is not limited to the embodiment(s) described herein but can be amended or modified without departing from the scope of the present invention.

We claim:

1. A method of operating a system for receiving and decoding packet-based video signals, comprising the steps of:
(a) receiving a packet-based data stream encoding a video signal;
(b) maintaining a set of rules, each rule specifying a content-matching condition and a corresponding action to be taken;
(c) providing an interface for a user of the receiving and decoding system to edit said set of rules;
(d) analysing the content of the packet-based data stream to determine whether the content thereof matches a condition specified in one of said rules;
(e) upon determination of a matching condition in said analysing step, implementing a corresponding action specified in said one of said rules, said action being effective to control a component which is under the control of said receiving and decoding system.

2. A method as claimed in claim 1, wherein the step of analysing the content of the packet-based data stream comprises decoding the packet-based data stream and analysing the decoded signal.

3. A method as claimed in claim 2, wherein the step of analysing the decoded signal comprises analysing an audio component of the decoded signal to detect audio content matching said condition in one of said rules.

4. A method as claimed in claim 3, wherein the step of analysing an audio component comprises applying speech analytics techniques to match detect a match with one or more spoken words or word patterns specified by said user in said interface for editing said set of rules.

6. A method as claimed in claim 2, wherein the step of analysing the decoded signal comprises analysing a video component of the decoded signal to detect video content matching said condition in one of said rules.

7. A method as claimed in claim 6, wherein the step of analysing a video component comprises applying pattern-matching techniques to identify a match with a visual element specified by said user in said interface for editing said set of rules.

8. A method as claimed in claim 7, wherein said visual element comprises a string of text.

9. A method as claimed in claim 1, wherein said step of implementing a corresponding action comprises implementing an action effective to control a component of said receiving and decoding system.

10. A method as claimed in claim 9, wherein said component of said receiving system is selected from: a decoder, a picture processor, a data stream controller, a channel selection system, a video or audio recording system, a “watch later” list, a program queue, a scene selection system for choosing between multiple scenes or viewing angles, an alerting system, an equipment display, an integral communications client (e.g. email, voice or video telephony, instant messaging, unified communications), and an embedded browser.

11. A method as claimed in claim 1, wherein said step of implementing a corresponding action comprises implementing an action effective to control a component of a system which is associated with and controllable by said receiving and decoding system.

12. A method as claimed in claim 11, wherein said associated and controllable system is selected from: a remote control unit, a television set, a display screen, a personal computer, a web server, a video recording system, and any other system which has been configured to grant permission to be controlled by the receiving and decoding system.

13. A method as claimed in claim 1, wherein said receiving and decoding system is implemented as a set-top box.

14. A method as claimed in claim 1, wherein said receiving and decoding system is implemented as a computer system operating suitable software to implement receiving and decoding functionality.

15. A method as claimed in claim 1, wherein said packet-based data stream is not selected for viewing by a user of the receiving and decoding system.

16. A computer program product comprising a program carrier encoding instructions which, when executed by a system for receiving and decoding packet-based video signals, are effective to cause the system to:
(a) maintain a set of rules, each rule specifying a content-matching condition and a corresponding action to be taken;
(b) provide an interface for a user of the receiving and decoding system to edit said set of rules;
(c) analyse the content of a received packet-based data stream encoding a video signal to determine whether the content thereof matches a condition specified in one of said rules;
(d) upon determination of a matching condition in said analysing step, implement a corresponding action specified in said one of said rules, said action being effective to control a component which is under the control of said receiving and decoding system.

17. A system for receiving and decoding packet-based video signals, comprising:
(a) a network connection for receiving a packet-based data stream encoding a video signal;
(b) a memory storing a set of rules, each rule specifying a content-matching condition and a corresponding action to be taken;
(c) an interface operable by a user of the receiving and decoding system to edit said set of rules;
(d) a content analysis system for analysing the content of the packet-based data stream to determine whether the content thereof matches a condition specified in one of said rules;
(e) a processor programmed to, upon determination of a matching condition in said analysing step, implement a corresponding action specified in said one of said rules, said action being effective to control a component which is under the control of said receiving and decoding system.
